(19) United States
(12) Patent Application Publication
(10) Pub. No.: US 2021/0253018 A1
(43) Pub. Date: Aug. 19, 2021

(54) TRANSPORTER ASSEMBLY

(71) Applicant: BRYAN FREEMAN, SAN CLEMENTE, CA (US)

(72) Inventor: BRYAN FREEMAN, SAN CLEMENTE, CA (US)

(21) Appl. No.: 17/174,926

(22) Filed: Feb. 12, 2021

Related U.S. Application Data
(60) Provisional application No. 62/976,929, filed on Feb. 14, 2020.
(60) Provisional application No. 63/020,710, filed on May 6, 2020.

(51) Int. Cl. B60P 7/08

(52) U.S. Cl. CPC B60P 7/0892

(57) ABSTRACT

Methods and assemblies for securing objects in position for transportation. In an example, two or more coupling bars secure to at least one frame, and in some examples two frames, in a pivoting fashion to allow an object to be secured therebetween for transport. In another example first and second holders, coupled together in pivoting fashion, are provided for receiving and holding an object for transportation. The apparatuses may find particular use for the transport of flat screen televisions and other video displays. Methods for using such a device are also disclosed.

### CROSS REFERENCE TO RELATED APPLICATIONS

The present application claims the benefit of and priority to U.S. Provisional Patent App. No. 62/976,929, filed Feb. 14, 2020 and titled TRANSPORTER ASSEMBLY, and also to U.S. Provisional Patent App. No. 63/020,710, filed May 6, 2020 and also titled TRANSPORTER ASSEMBLY, the disclosures of which are incorporated herein by reference.

### BACKGROUND

Video displays, such as televisions and computer monitors, have become thinner and larger with advances in LCD technology in particular. When the owner of a large flatscreen television moves from one residence to another, for example, or otherwise needs to move such a device, the typical approach is to wedge the video display between other items to keep it upright and protected, sometimes using a box to contain the display, bubble wrap to surround the display, and/or or draping a blanket over the screen to provide additional protection. If the load in a moving truck shifts, however, the screen or other parts of the video display can be damaged. The screen may instead be laid flat, however, some video displays also cannot be transported, without risk of damage, when laid flat.

Some artwork, such as paintings and framed photographs, as well as mirrors, tend to be large, flat, and difficult to safely transport. The most common advice for moving such items is to carefully wrap the item, using fabric, foam, bubble wrap and the like, and place it inside a large box. As with displays, the artwork or mirror in the box and bubble wrap may then be wedged between other large objects in the back of a moving truck, leaving the box and its contents at risk if the load shifts. Moreover, the use of bubble wrap and cardboard for such shipping tends to be wasteful.

New and alternative solutions to aid in the transportation of such items are much desired.

### Overview

The present inventors have recognized, among other things, that a problem to be solved is the need for new and/or alternative devices or systems to secure a video display for transportation. In some examples, a plurality of coupling bars are secured in pivoting fashion to one or more frames to allow the item to be transported to be secured therebetween, as further illustrated and described below.

This overview is intended to provide an introduction to the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an illustrative transport apparatus in an assembled, receiving configuration;

FIG. 2 is an exploded view of the apparatus of FIG. 1;

FIGS. 3A-3C are front, side and top elevation views of the apparatus of FIG. 1, in an open configuration;

FIGS. 4A-4C show side, front and bottom elevation views of a coupling bar;

FIGS. 5A-5B show front and bottom elevation views of a first frame;

FIGS. 6A-6B show front and bottom elevation views of a second frame;

FIGS. 7A-7B show front and bottom elevation views of an inner frame;

FIGS. 8A-8B show front and bottom elevation views of a linkage adapted for coupling an inner frame to a first or second frame;

FIGS. 9A-9C show an optional feature usable on any of the coupling bar, the first frame or the second frame;

FIGS. 10A-10C show the apparatus in a collapsed configuration;

FIGS. 11A-11C show the apparatus in used;

FIGS. 12A-12B show another example in perspective and side elevation views;

FIGS. 13A-13C show details of the example of FIGS. 12A-12B;

FIGS. 14-18 show use of the example of FIGS. 12A-12B;

FIG. 19 shows another example; and

FIGS. 20A-20D illustrate use of the example of FIG. 19.

### DETAILED DESCRIPTION

The following description focuses primarily on the use of the transport apparatus as described for securing and transporting video displays, such as large flatscreen televisions. Some examples may be used additionally or alternatively to transport other items having a large area and thin profile, such as paintings, photographs, other artwork, and mirrors, for example.

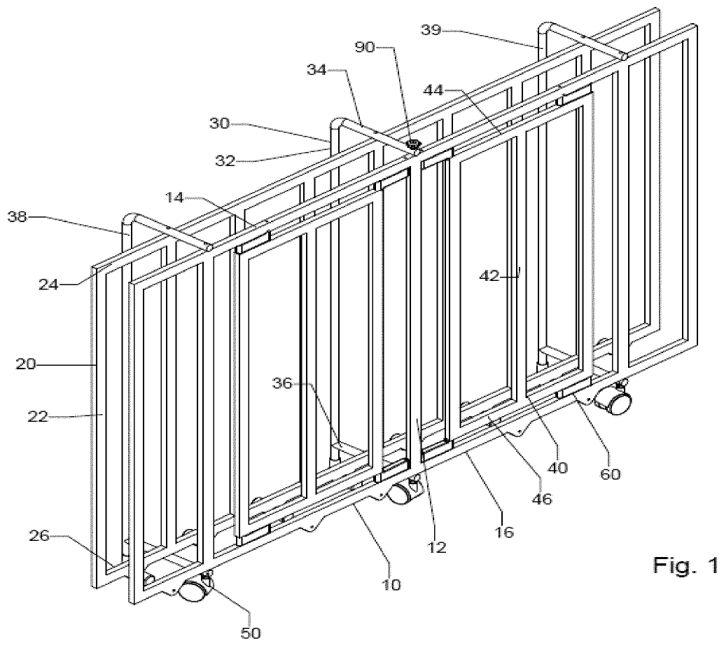

FIG. 1 is a perspective view of an illustrative transport apparatus in an assembled, receiving configuration. The assembly includes a first frame 10 having a plurality of first frame vertical bars 12, a first frame top bar 14, and a first frame bottom bar 16. The assembly also includes a second frame 20 having a plurality of second frame vertical bars 22, a second frame top bar 24, and a second frame bottom bar 26. The assembly also includes a coupling bar 30 having a coupling bar vertical member 32, and first and second horizontal members 34, 36. There may be a plurality of two or more coupling bars in various examples; in the illustrative example shown in FIG. 1, there are three coupling bars 30, 38 and 39, each of equal or similar construction.

The coupling bars are pivotally coupled to each of the first and second frames. For example, the first horizontal member 34 of coupling bar 30 is secured in a pivoting manner to the top bars 14, 24, and the second horizontal member 36 is secured in a pivoting manner to the bottom bars 16, 26 of the first and second frames. Such pivoting attachment may be by the use of, for example and without limitation, a bolt, rivet, a pin, and may be further facilitated by using a compound securing member such as a stainless steel bolt within a sleeve such as a hard plastic to allow quiet pivoting action. In an example, a bolt within a sleeve may pass through an opening in the horizontal member (34 or 36) and pass into a threaded connector welded into place inside the top or bottom bar of the frame.

In an example, as further shown below, one or more of the pivoting attachments between the coupling bars 30, 38, 39 and the frames 10, 20 may facilitate locking a relative configuration to secure the assembly in a collapsed or stowed configuration, or to secure the assembly, once loaded with items for transport, in a position that secures the items.

Optionally, and as shown, the second frame may also include an inner frame 40 that is moveable relative to the second frame. The inner frame 40 has a plurality of vertical bars 42, a top bar 44, and a bottom bar 46, in this example, and is secured in place with linkages shown at 60. The inner frame 40 may be used to pivot into a space defined between the first and second frames to provide additional securing force to items stored therein. A locking mechanism may also be provided relative to one or more of the linkages 60, to secure the inner frame 40 in a desired position.

The assembly may, optionally, also include one or more wheels 50 attached to one or more of the first and second frames 10, 20, to support the weight of the apparatus relative to a well. In use, the coupling bars 30, 38, 39 may be secured in a pivoting fashion, such as by the use of pipe fasteners, to a wall, such as a wall of a moving truck. The inclusion of the wheels 50 may reduce the force that the wall absorbs during use.

In one approach to using the assembly, it may be installed in a moving truck such as a rental vehicle, using, for example, pipe fasteners to secure the coupling bars 30, 38, 39 to a wall thereof in a pivoting fashion. At the time of rental, the assembly in a collapsed or stowed configuration (not shown) with the first and second frames 10, 20 relatively closer to one another than what is shown in FIG. 1, with the coupling bars 30, 38, 39 at an acute angle relative to each frame. This position may be secured, as indicated above, with one or more of the pivoting attachments of the coupling bars 30, 38, 39 providing a locking force. To allow tracking of whether assembly is used, a paper or plastic band may be placed, for example around the top bars 14, 24, which will then break if a user releases the assembly from the stowed configuration.

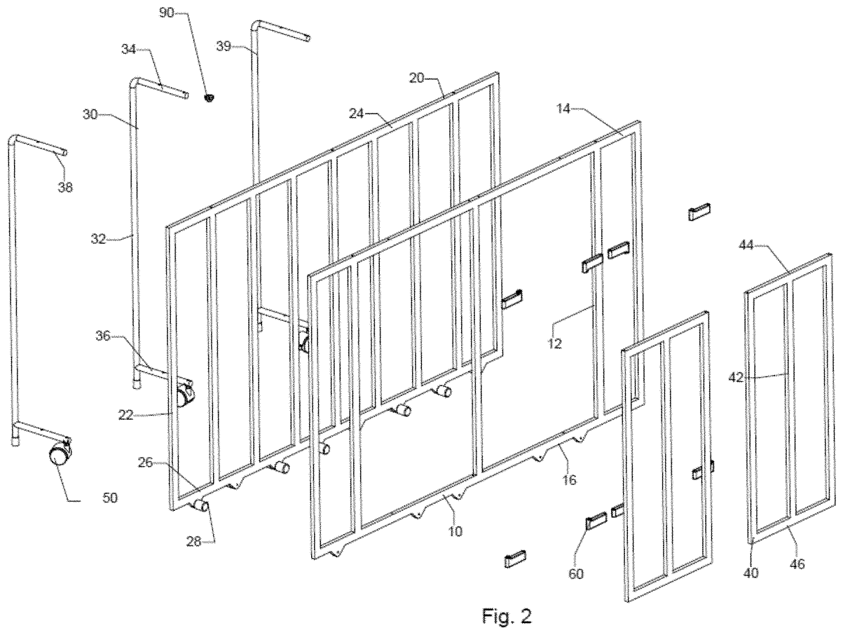

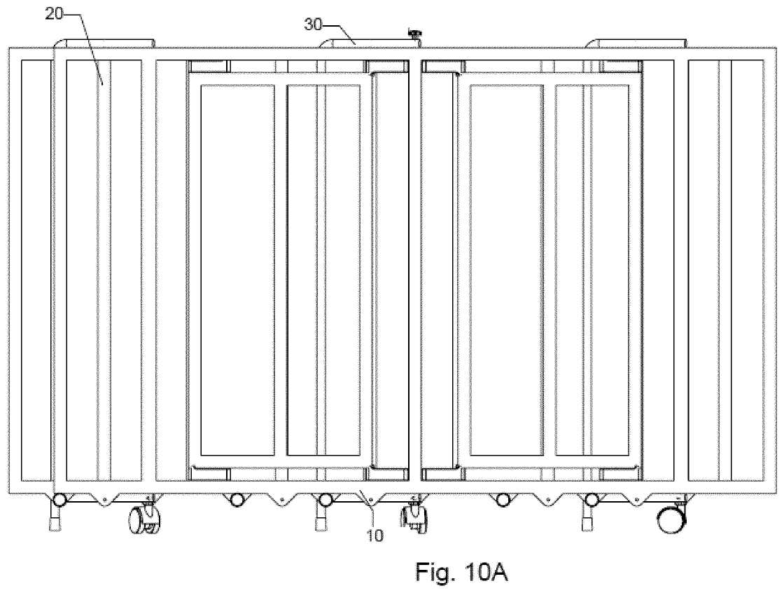

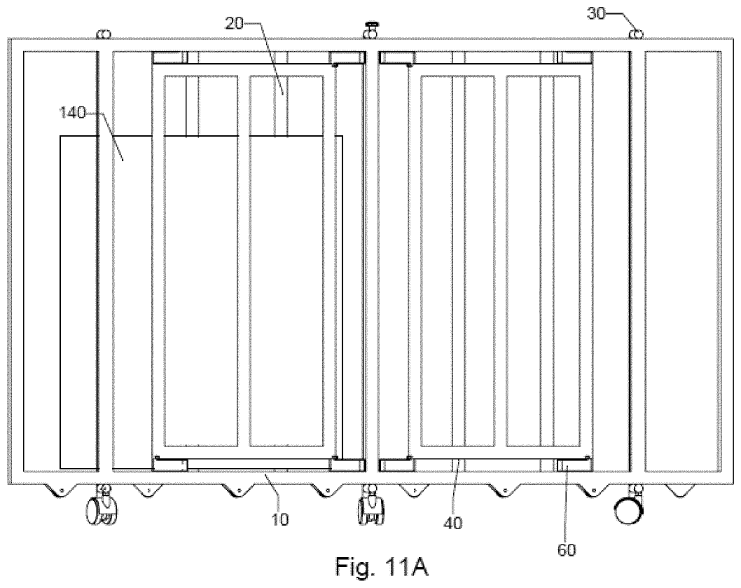

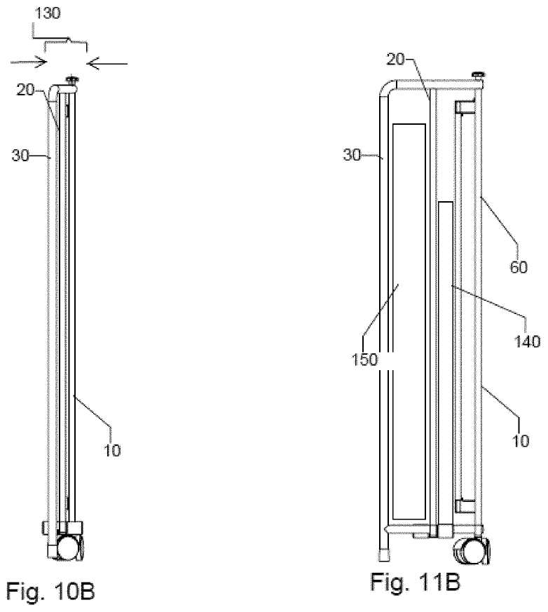

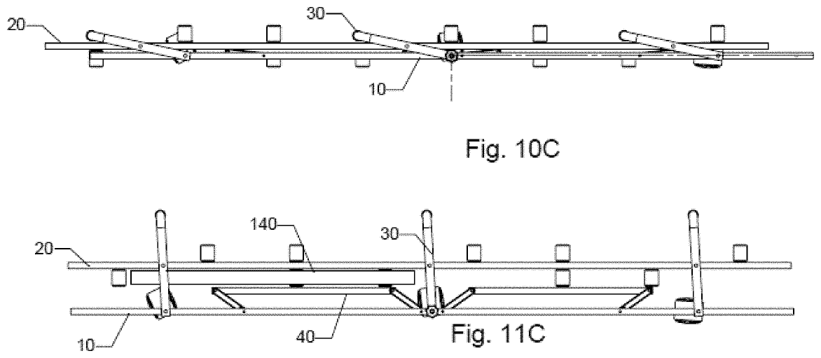

When a user releases the assembly from the stowed configuration, the first and second frames 10, 20 become spaced from one another, and the first frame 10 becomes spaced from the vertical members 32 of the coupling bars 30, 38, 39, creating spaces into which an item to be transported may be inserted. The bottom horizontal member 36 of the coupling bars may have rolling sleeves thereabout to aid in sliding the item to be transported into the space that is opened between the first and second frames 10, 20, or between the first frame 10 and the vertical member 32 of the coupling bars 30, 38, 39. If a smaller item is to be transported, the inner frame 40 can be pivoted into the space between the first and second frames 10, 20 to limit movement of the smaller item. As shown in FIG. 10, below, there may be additional supports built into the first and second frames, or into the vertical member 32, to allow placement of multiple levels (vertically) of items. Once the items to be transported are placed, the assembly may be pressed in again to reduce the space between the first and second frames 10, 20 and between the first frame 10 and the vertical member 32 as the coupling bars pivot relative to the first and second frames 10, 20. Wheels 50, if provided, can help support the weight of the placed items as well as the assembly itself. A locking pivot (see FIG. 2, below) can then be used to secure the assembly in a partly collapsed position, thereby securing the items to be transported.

Placement may be in a rental truck, as indicated above, though other uses are also contemplated, including, without limitation, in any transportation vehicle (airplane, automobile, train, boat), as well as in shipping containers, such as a portable on-demand storage (PODS®) type of system.

FIG. 2 is an exploded view of the apparatus of FIG. 1, with some added details and options. The first frame 10 is shown having the vertical bars 12, top bar 14, and bottom bar 16. The second frame 10 is shown having the vertical bars 22, top bar 24, and bottom bar 26. In addition, as shown more clearly in FIG. 2 than in FIG. 1, the second frame bottom bar carries a number of rollers that allow an item to be stowed to be easily placed by sliding into the space between the second frame and the first frame. In some examples, the rollers 28 may also be placed between the second frame and the coupling bar(s). The coupling bar 30 is shown with the vertical member 32, first horizontal member 34 and second horizontal member 36. The inner frames are also shown, including an inner frame 40 with vertical bars 42, top bar 44 and bottom bar 46. Linkages 60 are shown as well, for coupling the inner frame 40 to the first frame 10. One or more wheels 60 can be included, such as castor wheels.

For attaching the apparatus to the wall, whether in a vehicle or a container, several pipe fasteners (not shown) may be used in an illustrative example. In another example, hooks may be used to hold the coupling bars to a structure (similar to ballerina bars) commonly found in moving trucks, other vehicles of transport, and/or containers. In other examples, the apparatus can be attached to a wall and/or floor by straps, such as Velcro straps (similar to those used for earthquake proofing), which would allow the apparatus to be readily removed from an installed position if not needed, for example, in a moving truck for a particular move. Other suitable attachments may include clamps, rope, chain, canvas, vinyl, plastic, wood or synthetic material attachments.

A locking pivot apparatus is shown at 90, and may include a knob that can be manually actuated to tighten any of the pivoting attachments between the coupling bar 30 and either frame 10, 20. Multiple locking pivot apparatuses 90 can be used, if desired.

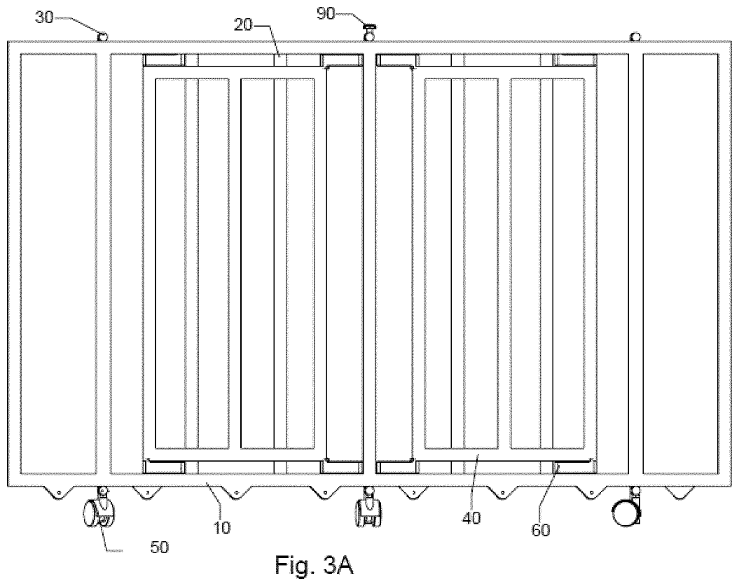

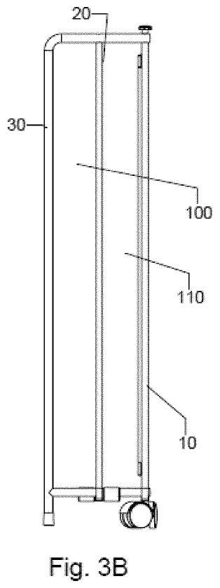

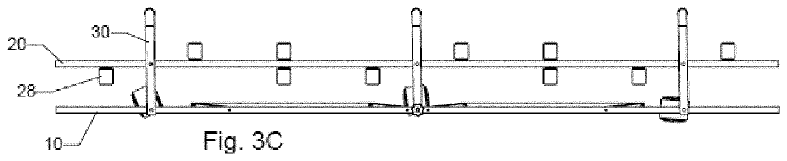

FIGS. 3A-3C are front, side and top elevation views of the apparatus of FIG. 1. The front elevation view of FIG. 3A shows how the coupling bar 30 extends above and below each of the frames 10, 20, and the inner frame(s) 40 can be attached to the first frame 10.

The overall size of the apparatus may vary to a significant extent. Some examples have a total width in the range of about 60 to about 100 inches, or about 70 to about 90 inches, or about 85-90 inches. The height may be in the range of about 36 to about 84 inches, or about 48 to about 60 inches. One example has a width of about 86 inches and a height of about 53 inches. Still larger sizes may be used as screen sizes continue to expand, if necessary. Some examples may be smaller to accommodate different size installations; for example, smaller moving trucks or moving vans may be equipped with smaller assemblies, as needed. The inner frame may have any suitable size, in the range, for example, 12 to 36 inches wide and 36 to 50 inches tall, or smaller or larger. The examples shown herein have two inner frames, but other examples contemplated by have a single inner frame, or may have three or more inner frames.

Each of the vertical members/bars, top bars, bottom bars, and horizontal bars may be provided with a padded cover, such as a cloth or foam wrapping or sleeve, to cushion any elements loaded therein. The vertical members/bars, top bars, bottom bars and horizontal bars may be round, square, rectangular, square-ish (sqround), or any other suitable shape. ½ inch or ¾ inch bars, whether round or square, may be readily padded using off-the shelf insulation/padding products made for plumbing/insulation purposes, if desired. Other diameters, larger or smaller, may be used. In some other examples, flat walls may cover, or solid flat pieces (such as plywood or plexiglass) may be used in place of one or more bars or vertical or horizontal members. A molded screen approach may be used.

The frames 10, 20, 40 and coupling bars 30 may be made with any suitable material or combination of materials, including for example, metal (steel, aluminum, tin, copper), wood, plastics and/or synthetics (polyvinyl chloride, for example), composites, etc. In some examples, padding made of plastic, foam, composite materials, fabric, cellulose, etc. may be used on or between the frames and/or coupling bars, if desired.

The side view in FIG. 3B shows how the apparatus, when in an open configuration, defines a first receiving space 100 between the coupling bar 30 and the second frame 20, and a second receiving space 110 between the first frame 10 and second frame 20. The spaces 100, 110 may be, for example, in the range of about 4 inches to 14 inches deep in the open configuration. In another example, the spaces 100, 110 are about 6 to 10 inches deep in the open configuration. The pivoting action of the coupling bar relative of the frames 10, 20 allows the device to be stowed down to a total depth of about 2-5 inches, or about 3 inches. The horizontal members, particularly the lower horizontal members, may be provided with one or more rollers or rotatable sleeves to allow an item to be transported to more easily slide into position in either of the spaces 100, 110.

The top view in FIG. 3C shows how the rollers 28 may extend into the spaces highlighted in FIG. 1A. Larger or longer rollers may be used in other examples. A plurality of rollers may be linked together to fold up for stowage, and to fold down for supporting an object to be transported, if desired. In still another example, flexible sheets, or folding members, such as fabric or plastic, including for example, vinyl, connect the frames 10, 20 to one another, as well as connect between the coupling bars 30 and second frame 20, at the lower margin thereof to provide a surface on which to slide or rest an item to be stowed.

It should be understood as well when looking at the top view in FIG. 3C that additional contemplated embodiments would allow independent movement of the frames 10, 20 relative to the coupling bars 30 by, for example, adding linkages 60 to couple each frame to the coupling bars 30. This may be useful to enable secure stowing of different size/thickness items within each space 100, 110 (FIG. 3B). Additional securing structures, such as the knobs highlighted at 90, may be provided to allow the apparatus to be secured in a desired position with this added flexibility.

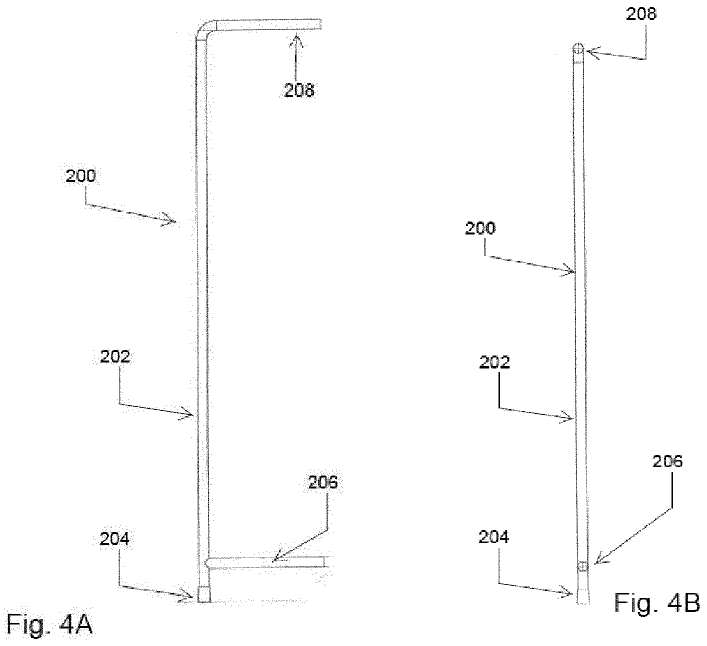

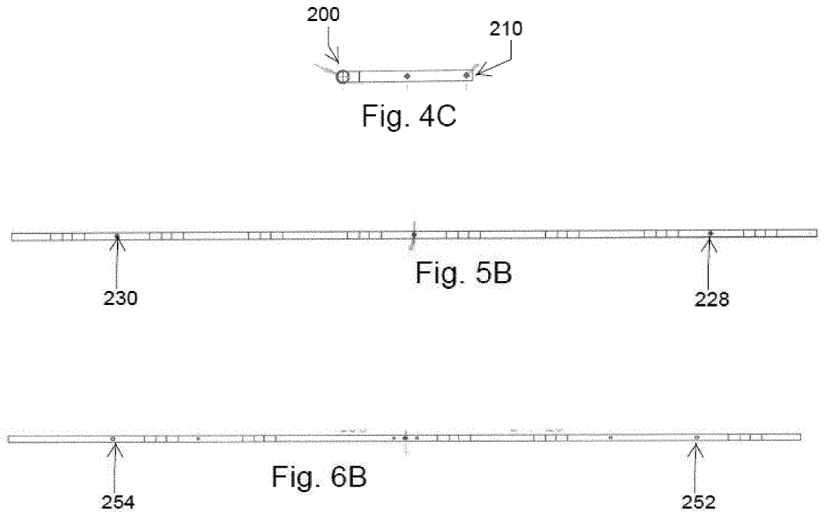

FIGS. 4A-4C show side, front and bottom elevation views of a coupling bar. As shown in FIGS. 4A-4C, the coupling bar 200 has a vertical member 202 ending at its bottom in a foot 204, which may have a rubber/plastic pad placed thereover if desired. The first horizontal member 206 may be, for example, 2-4 inches above the ground. The second horizontal member 208 is also shown. For manufacturing purposes, if metal is used, the first horizontal member 206 may be welded and/or bolted onto the coupling bar 200 vertical member, which can be bent as shown to provide the second horizontal member 206. In other examples, the second horizontal member 208 may be attached to the vertical member by welding and/or bolting together. In still other examples, the coupling bar may be cast or molded in the shape shown. In an example, one or more corners where horizontal and vertical members connect may be achieved using preformed joints that attach to a tube or pipe.

As shown in FIG. 4C, the horizontal members may include pre-made holes for securing pins that allow the pivoting coupling to the first and second frames. As indicated previously, it is contemplated that 2, 3, 4 or more such coupling bars may be used, though several examples shown herein use 3 for illustrative purposes.

The first, second and inner frames may be manufactured in any suitable manner. In one example, top and bottom bars of each frame are molded plastic, with the vertical members being hollow metal pieces, such as pipes or square tubes. In another example, plastic or metal corner connectors are used for joining together pipes or other metal members at the outer corners, and plastic or metal connectors are provided on the top and bottom bars to couple to vertical members. In another example, some joints, such as outer corners, are provided using connecting members while others are welded.

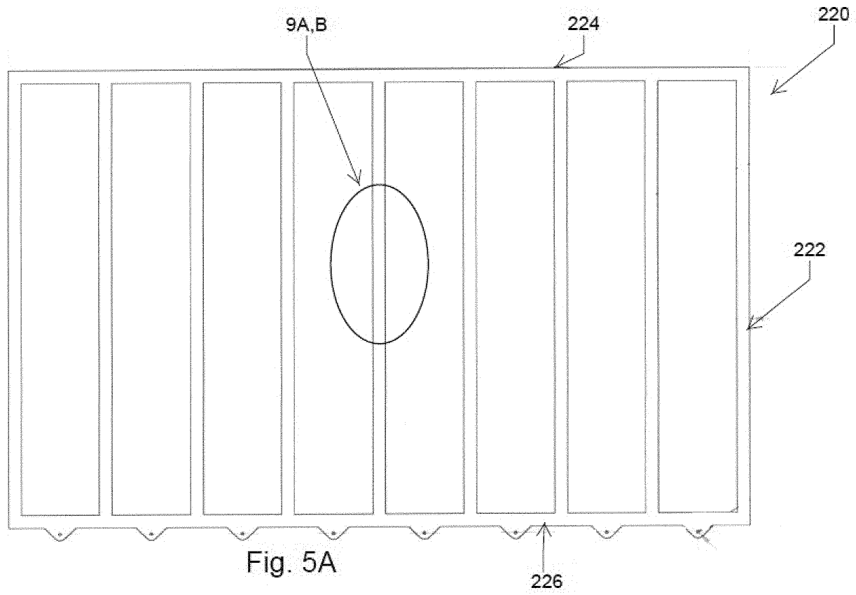

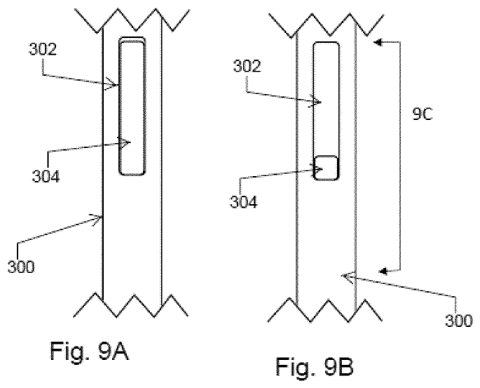

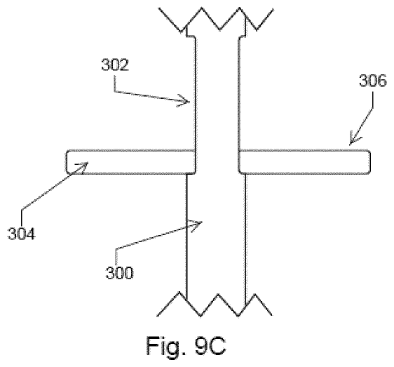

FIGS. 5A-5B show front and bottom elevation views of a first frame. The first frame 220 is shown having a plurality of vertical bars 222, a top bar 224 and a bottom bar 226. An area highlighted as 9A,B corresponds to views shown below in FIGS. 9A-9B, with the view of FIG. 9C being rotated 90 degrees relative to 9A and 9B. The bars may be spaced any suitable distance. In some examples, the bars are spaced about 6 to about 12 inches apart. One illustrative example has the bars spaced about 10 to about 11 inches, center to center. In other examples, the bars may be more closely spaced, for example, to define gaps of about 4 inches or less. As with the coupling members, the design shown may be assembled from individual metal bars, welded and/or bolted together, or may be cast of metal or a plastic, or may be a molded plastic piece; the same is true for the other frames shown below. In the bottom view of FIG. 5B, it can be seen that several pre-made holes are provided, such as at 228, 230, to allow for pivoting attachment to the coupling bars.

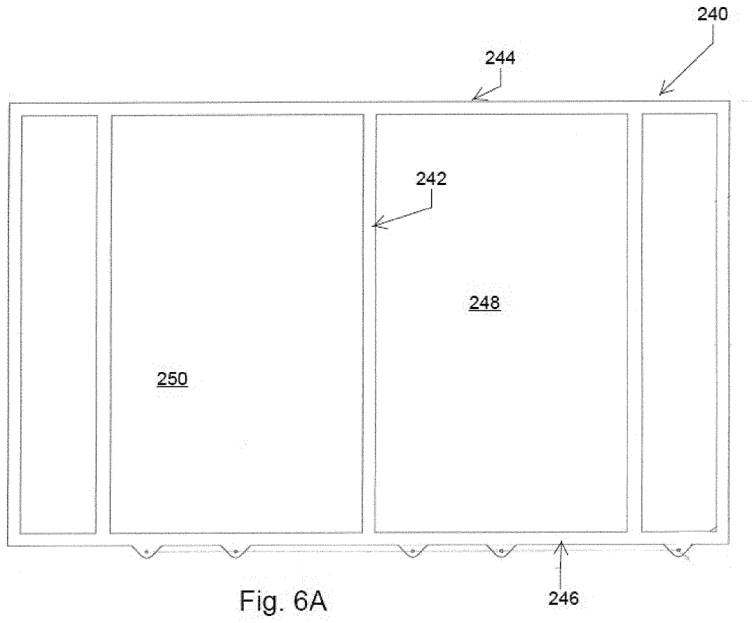

FIGS. 6A-6B show front and bottom elevation views of a second frame. The second frame 240 is shown having a plurality of vertical bars 242, a top bar 244, and a bottom bar 248. To accommodate the optional inner frame, the second frame has the vertical bars 242 spaced to define two larger gaps 248, 250 where the inner frames would go. The bottom elevation view of FIG. 6B again shows the inclusion of pre-made holes for receiving pivot pins for securing the second frame 240 to the coupling bars. Though not shown, the inner sides of the top and bottom bars may also include pre-made holes for coupling to the linkages that connect the inner frame to the second frame 240.

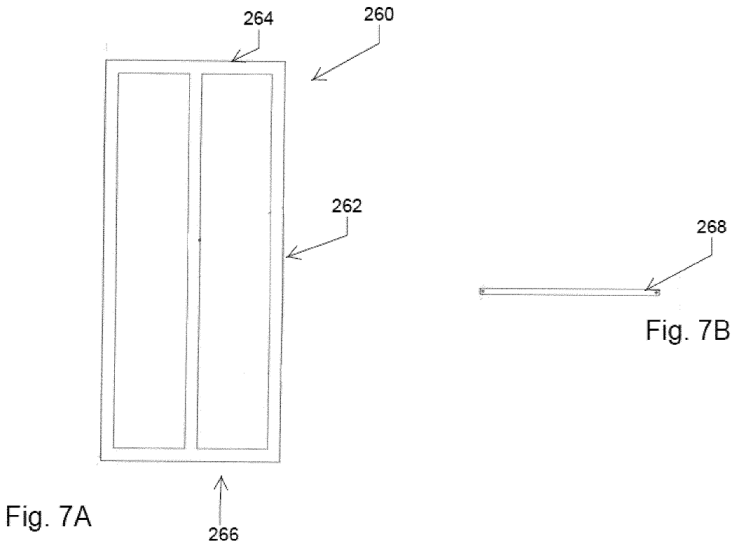

FIGS. 7A-7B show front and bottom elevation views of an inner frame. The inner frame 260 includes vertical bars 262, a top bar 264, and a bottom bar 266. As shown in the bottom elevation view, pre-made holes are provided at 268, for example, for connecting to the linkages that conned, in turn, to the second frame.

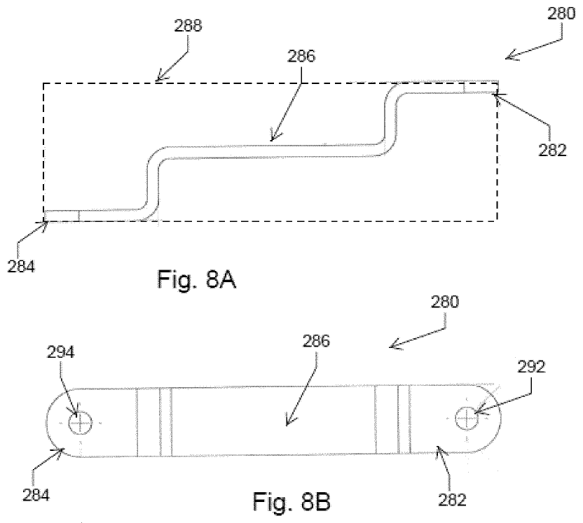

FIGS. 8A-8B show front and bottom elevation views of a linkage adapted for coupling an inner frame to a first or second frame. The linkage 280 may be a metal piece, such as aluminum or stainless steel, or any other suitable material (including other metals as well as plastics), with a first connecting portion 282 and a second connecting portion 284, having an intermediate piece at 286 therebetween. As shown in FIG. 8B, each connecting portion 282, 284 has a respective hole 292, 294 for use in attaching to the second frame and inner frame. If desired, an alternative approach would be to use a block as outlined at 288 in FIG. 9A, such as a wood block.

FIGS. 9A-9C show an optional feature usable on any of the coupling bar, the first frame or the second frame. A center portion of a vertical member or bar is shown at 300, having a slot 302 that holds a support bar 304. The support bar can pivot in and out of the slot 302, as shown in FIG. 9B, to about a 90 degree angle, as shown in the side view of FIG. 9C. By providing such support bars 304 in the vertical members or bars of the first frame and/or, optionally, the second frame or coupling bars, an additional level for storage becomes available in the spaces defined between the coupling bars and first and second frames. The support bars 304 may be, for example, plastic elements that are snapped or slid into place in the slots, or may be metal pieces that can be held in position by rivets or bolds that pass through the vertical member/bar. In one example, a magnet is positioned in the vertical bar, and the support bars 304 are made of a ferrous material (such as an iron-containing alloy, including, for example, stainless steel), so that the support bars are held in place by a magnet when not in use, and can be easily manipulated to the down position shown in FIGS. 9B-9C for use.

FIGS. 10A-10C show the apparatus in a stowed configuration, with front, side and top elevation views. As shown in FIG. 10A, the coupling bars 30 are pivoted to be nearly parallel to the first and second frames 10, 20. FIG. 10B illustrates that the outer dimension or depth 130 taken by the apparatus is generally reduced, as shown, to approximately a sum of the thickness of each element (first frame 10, second frame 20 and coupling bars 30). In the top view of FIG. 10C, the pivot of the coupling bar 30 is shown clearly. If rollers are provided, as shown in FIG. 10C, these may be sized to avoid sticking out beyond the rest of the structure when fully collapsed as in FIGS. 10A-10C; in other examples the rollers may tip up or retract, either individually or as a group, if desired.

FIGS. 11A-11C show the apparatus holding an object to be transported in front, side and top elevation views. As shown in each view, an object 140 is placed between the first frame 10 and the second frame 20. If desired, as highlighted in FIGS. 11A-11B, the inner frame 40 can be pivoted inward to secure the apparatus in a desired position. As highlighted in only FIG. 11B, a second object 150, which may be a different size than the first object 140, can be placed between the coupling bars 30 and the second frame 20.

In a use context, the apparatus may be stored in a minimized or collapsed configuration as shown in FIGS. 10A-10C. If provided in a rental truck, for example a moving truck, a strap may be secured around the frames or coupling bars that would have to be broken in order to use the apparatus. If the strap is not broken, the user may not be charged for use of the apparatus in the rental vehicle. In other examples, installation may use Velcro, and the apparatus can be removed from such a truck if the renting person indicates she does not wish to use it.

To use the apparatus, the user would loosen the securing knob 90 and pivot the apparatus to an open configuration, opening the spaces 110, 120 between the frames and coupling bars. The items to be transported, such as artwork or video displays, would then be inserted into a suitable space. The apparatus can then be pivoted to a reduced width, and/or the inner frames 40 can pivoted inward as shown in FIGS. 11A-11C to secure the item to be transported. The securing knob(s) 90 can then be used to hold the apparatus in a position that secures the item(s) to be transported. On reaching the destination, the securing knob(s) 90 are loosened, allowing the frames 10, 20 and coupling bars 30 to move again. The apparatus may be pivoted to a fully open position and the transported items removed.

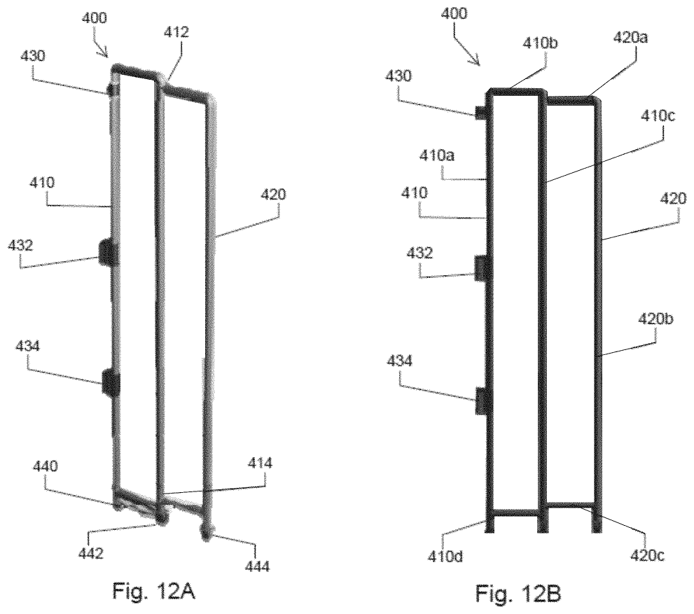

FIGS. 12A-12B show another example in perspective and side elevation views. In this example, the apparatus for transporting an item 400 includes a first holder 410 and a second holder 420. The first holder 410, as shown in FIG. 12B, has a back bar 410a, a top bar 410b, a front bar 410c, and a bottom bar 410d. The back bar 410a carries one or more couplers 432, 434 and an upper leg 430, design and use of which is further illustrated below. The second holder 420 includes a top bar 420a, a front bar 420b and a bottom bar 420c. Pivoting attachment of the second holder 420 to the front bar 410c of the first holder 410 is shown at 412, 414 and may be achieved by, for example, having two encircling couplers which are linked together at by a pivot. If desired, the bottom bars 410d and 420c may include one or more rollers thereabout, or may omit rollers, as shown.

The back bar 410a can have a base that extends below the bottom bar 410d ending in a foot 440. The front bar 410c of the first holder 410 also is shown extending below the bottom bar 410d to a castor wheel 442, while the front bar 420b of the second holder 420 also is shown extending below the bottom bar 420c to a castor wheel 444. While not shown, if desired, a locking pivot apparatus can be included to fix the angle of the pivot between the first holder 410 and second holder 420, if desired, using for example a structure as in item 90 shown above. In another example, a locking pivot apparatus (or more than one such lock), such as the design shown at 90 above, may be provided at the coupling of the first holder 410 to the wall via the couplers 432, 434 and/or upper leg 430. For example, a locking screw may be provided at the junction of any one or more of the upper leg 430 and/or couplers 432, 434 to the back bar 410a. Such locking pivots can be used for securing an item to be transported, or for securing the apparatus 400 in a stowed position against a wall rail.

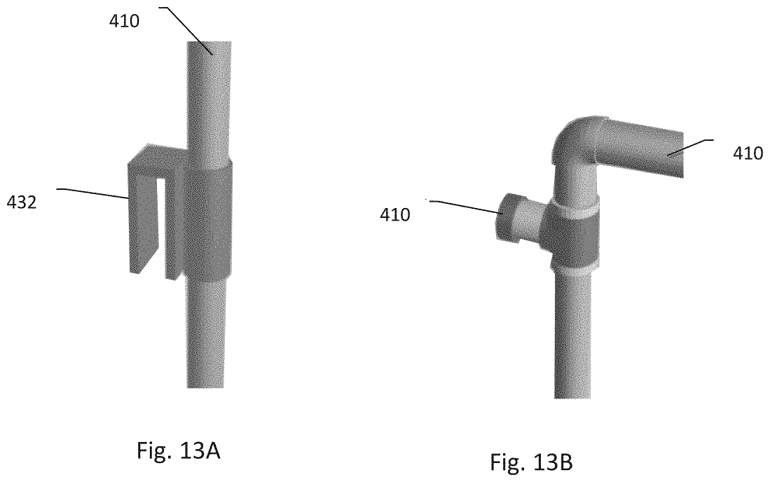

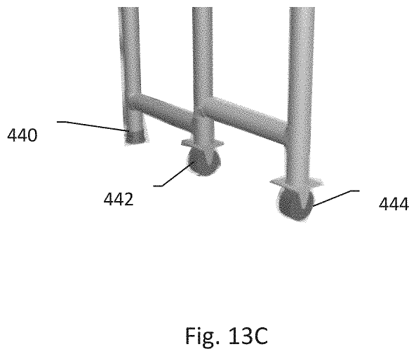

FIGS. 13A-13C show details of the example of FIGS. 12A-12B. As shown in FIG. 13a, the back bar of the first holder 410 carries a coupler 432 for securing the first holder 410 to a wall, for example, the wall in a transportation vehicle (such as a truck, boat or airplane). Such walls are often equipped with horizontally extending rails (sometimes referred to as ballet bars). As can be seen in FIG. 13A, the coupler 432 has a U-shape facing down, and is sized for placement on the horizontal rail inside of a moving truck. If desired, a clamp may be provided to affix the coupler 432 to the horizontal rail, though this is not required in many embodiments. FIG. 13B shows an upper leg 432 at the upper end of the back bar of a first holder 410. The upper leg 432 can be an adjustable length piece (such as having a threaded inner piece) to allow it to be extended/retracted to press against the wall of a transportation vehicle, providing tension against the horizontal rails to fix the position of the first holder 410. The upper leg 430 and coupler 432 are pivotally attached to the first holder 410. In some examples, the vertical position of the upper leg 430 and/or coupler 432 can be adjustable as well, to accommodate differing configurations of the rails in various transportation vehicles.

FIG. 13C shows details at the bottom of the device 400. A rubber foot 440 is placed at the bottom of the back bar (other materials may be used within the scope of the present invention) of the first holder. Castor wheels 442, 444 (or other wheel types) are provided at the bottom of the front bar of the first holder and at the bottom of the front bara of the second holder, as shown. Optionally in an example, the castor wheel 442 is fixed relative to the axis of the first holder front bar, while castor wheel 444 is allowed to rotate about the axis of the second holder front bar. If desired, the castor wheels 442, 444 may be locking castor wheels to aid in holding the position of the holders 410, 420 fixed when loaded with an item for transportation.

Rather than a two piece attachment with a pivot member, as shown in FIG. 13C, the second holder can be pivotally secured to the first holder by a simpler design with the bottom bar of the second holder having a loop extension that wraps about the first holder. The same or similar structure may be used at the top bar of the second holder, optionally with a locking screw.

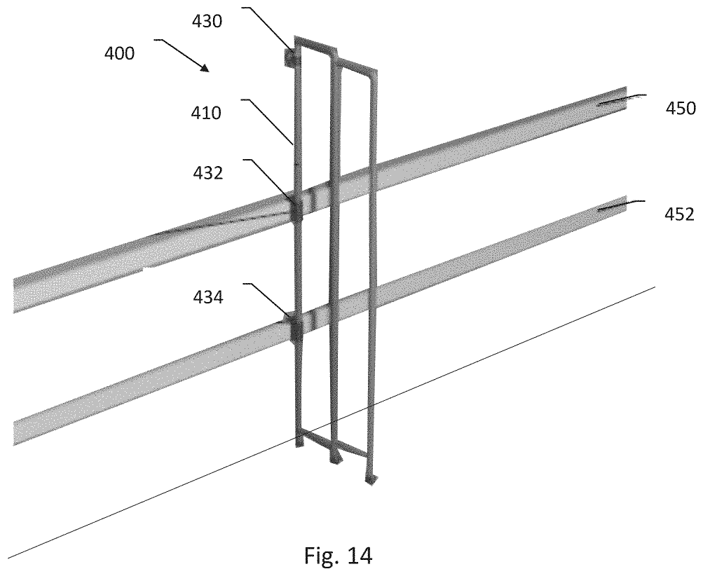

FIGS. 14-18 show use of the example of FIGS. 12A-12B. FIG. 14 shows an apparatus for transporting an item at 400, with couplers 432, 434 secured to horizontal rails 450, 452. The upper leg 430 abuts the wall of the transportation vehicle. If desired, additional legs can be provided lower on the first holder 410. As described above, the upper leg 430 has an adjustable length; when the upper leg 430 is retracted the apparatus 400 can be moved in the horizontal direction or removed entirely. Also, as noted, the couplers 432, 434 can be adjusted in the vertical direction to accommodate different rail configurations. A single coupler 432, 434 may be used, or more than two, as desired. While the system shown is generally adapted for use with a rail system in the transportation vehicle, different coupler designs may be used to account for different rail shapes or sizes, as desired. For example, if no rail is provided and instead a hook system is provided, the couplers 432, 434 may be shaped/sized to interact with wall hooks.

The sizes of various components can vary. For illustrative purposes only, some numeric examples are provided. In an example, the couplers 432, 434 may have the U-shape shown with a depth of about 2 to about 4 inches (2.5 inches, in one example), and a spacing of about 0.5 to about 2 inches (0.75 inches, in one example), to receive, for example, a standard (nominal) 1×4 slat, with the couplers 432, 434 made of, for example, 0.25 inch stainless steel or aluminum (or any other suitable metal or hard plastic). The bars of the first and second holders may be, for example, 1 inch piping made of PVC, aluminum, or other suitable materials (including materials listed above for other components); pipe can be used or other shape (solid, square, etc.). The space defined within each holder may be, for example, about 5-10 inches wide (6.5 inches in one example) and about 45 to 75 inches tall (about 56 inches in one example). If desired, the height defined by each holder can be adjustable by having first and second adjustable pieces coupled together (such as having a smaller pipe within a larger pipe). Likewise, the width of the space defined within each holder may be adjustable using a pipe within a pipe design, if desired, for the top and bottom bars.

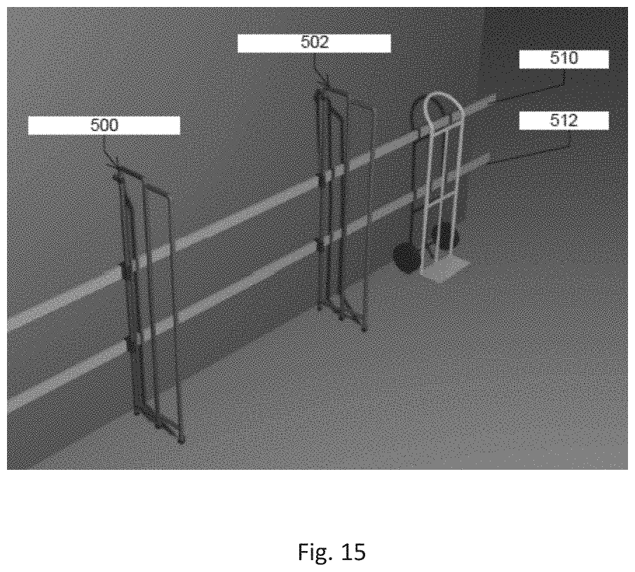

FIG. 15 shows a transportation system having first and second apparatuses at 500, 502, spaced apart a desired distance. If a standard distance is needed, the wall or rails 510, 512 may have markings to allow, for example, the apparatuses 500, 502 to be appropriately spaced for various size items to be transported so, for example, a lesser spacing can be used if moving a 50 inch television, or a greater spacing when moving an 80 or 110 inch television. More than two of the apparatuses 500, 502 may be used if desired for larger apparatuses. In some examples, a bottom shelf or rail may be placed on the bottom bars of the two apparatuses 510, 502, though this is not required. A front guard may be provided as well, such as a board that can slide within the apparatuses 500, 502 to protect the contents thereof against impact.

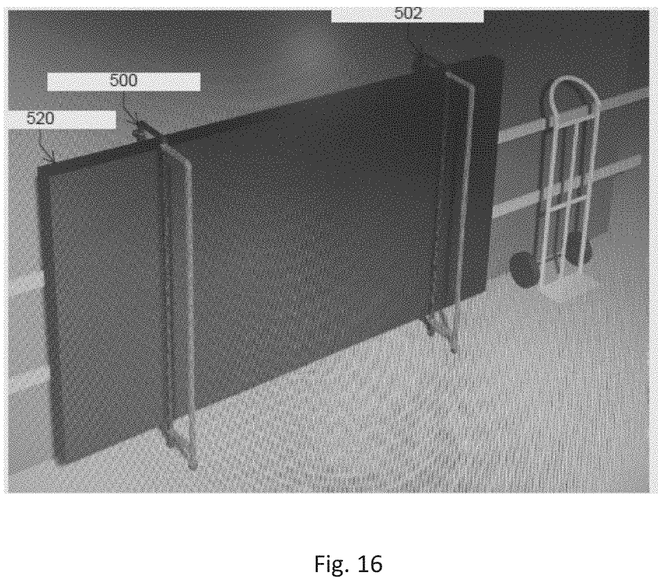

FIG. 16 shows a large item for transport, such a big screen television, mirror, or piece of artwork, loaded into the system of FIG. 15. The item 520 is slid in from the side into the space defined by the first holders of the two apparatuses 500, 502 with the apparatuses 500, 502 open more or less perpendicular to the wall of the vehicle.

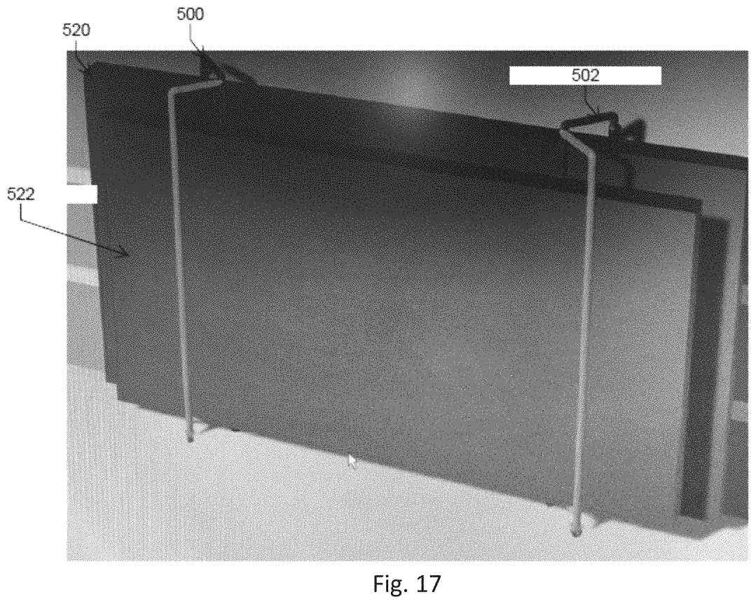

As shown in FIG. 17, a second item 522 can then be loaded into the space defined between the second holders and the front bar of the first holders of the apparatuses 500, 502, again sliding in from the side with the apparatuses 500, 502 more or less perpendicular to the wall. Once the items 520, 522 are placed, the apparatuses 500, 502 can be retracted as shown, pivoting relative to the wall and with the first and second holders pivoting relative to one another to a position that secures the items 520, 522 in position. When so placed, a strap may be wrapped around the apparatuses and items, if desired, to hold everything in place. Alternatively, locking screws can be provided at the pivot points of the first and second holders, as noted above, which may be tightened to maintain the position shown in FIG. 17. To aid in holding the items in place, the castor wheels may also be lockable.

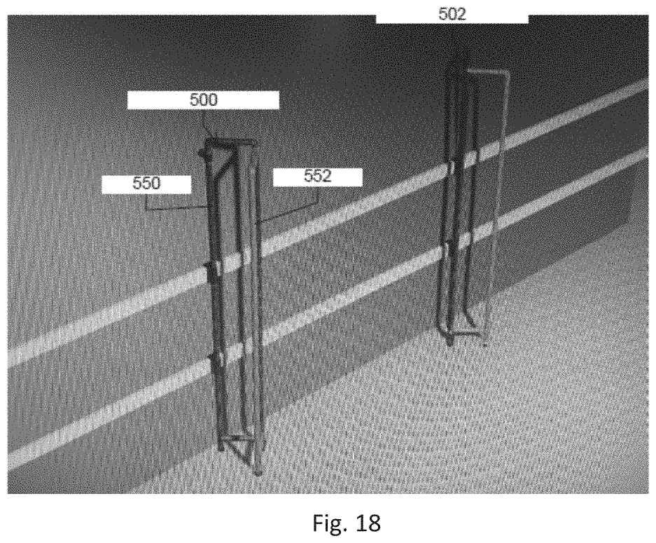

FIG. 18 shows the holding position with the items 520, 522 removed. As can be seen, the first holder 550 is pivoted relative to the wall and rails, and the second holder 552 is pivoted relative to the first holder 550. If the item held between the second holder 552 and first holder 550 is smaller, the second holder 552 may pivot in the opposite direction from that shown, inward relative to the other apparatus 502. As noted, any of straps, locking screws, and/or locking castor wheels can be used to aid in holding this position.

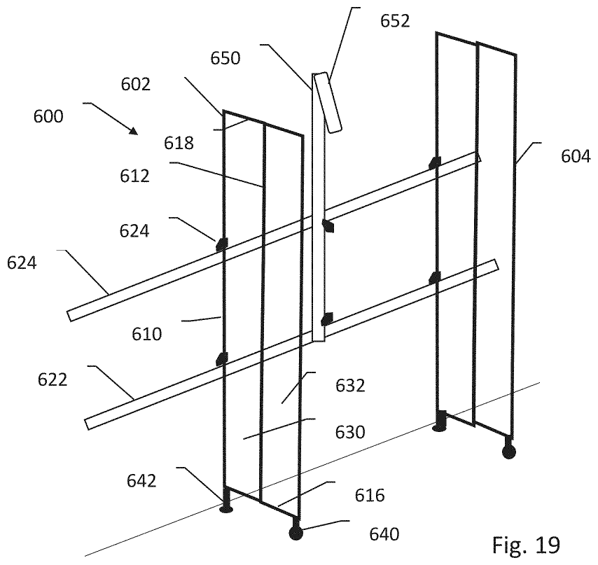

FIG. 19 shows another example. Here, a system for securing a transport item in a transportation space having a wall is illustrated. The system as shown at 600 includes at least a first holder 602 having an inner bar 610, a middle bar 612, and an outer bar 614, each illustrated as vertical bars. The first holder 602 also includes a bottom bar 616, and a top bar 618. The first holder 602 is secured by one or more brackets 620 to the wall bars 622, 624, as shown. The brackets 620 may secure the first hold in a pivoting manner at a first location relative to the wall, and a second holder 604 of similar design and similar pivoting attachment to the wall is shown spaced away from the first holder 602. In this example, as opposed to several earlier examples, the first and second holders 602, 604 are fixed and cannot pivot in the middle, potentially making for a cheaper installation requiring less assembly and fewer moving parts.

The system further includes a hook or strap 652 having a first end secured relative to the wall and a second end configured to attach to the top bar of the first holder. In the example shown, the strap 652 is secured to the wall bars 622, 624 by a bar or pipe 650 having brackets thereon. For example, the brackets on the bar 650 may be moveable The strap 652 may be elastic so that it can stretch to place tension on (and thus secure) a stored element occupying the spaces 630, 632 bounded by the vertical, top and bottom bars when attached to the top bar 618. In another example, the strap 652 is inelastic and have and adjustable securing structure (such as Velcro loop, or multiple snaps located at various lengths) More particularly, in the example shown, each of the first and second holders define first and second receiving spaces 630, 632 for receiving an item to be transported therein, said first receiving spaces 630 bounded by the respective inner 610 and middle 612 vertical bars and bottom 616 and top 618 bars, and said second receiving spaces 632 bounded by the respective middle 612 and outer 614 vertical bars and bottom 616 and top 618 bars.

First and second holders 602, 604 may be supported relative to the container floor or truck bed (for example, assuming a container or truck is the space in use), by a post 642 and castor wheel 640, if desired.

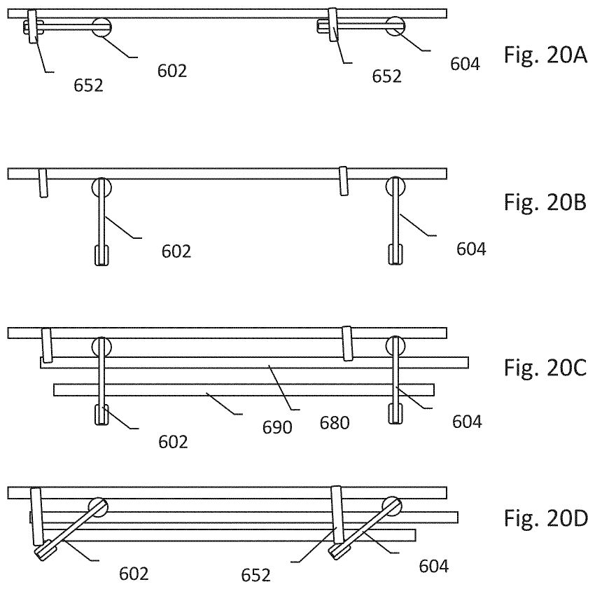

FIGS. 20A-20D show how one or more items can be stored using the system of FIG. 19. FIG. 20A shows a stowed configuration, with each of the first and second holders 602, 604 in a pivoted position adjacent the wall, optionally held in this position by the straps 652. An open configuration is shown in FIG. 20B, with the holders 602, 604 released from the straps and pivoted to about 90 degrees relative to the wall. As shown in FIG. 20C, items 680, 690 to be stored/transported, such as a mirror, television, artwork, etc. are placed in the spaces 630, 632 (FIG. 19) of the first and second holders 602, 604 by sliding into position as described for other examples above. Next each of the holders 602, 604 is pivoted toward the wall, as shown by FIG. 20D, and the straps 652 are secured to at least one of the holders 604. Two straps are shown in FIGS. 20A-20D, but it should be understood that a single strap may be used. Two holders are illustrated in FIGS. 20A-20D at 602, 604, but three or more such holders may be used in other examples. In the examples of FIGS. 19 and 20A-20D, each holder 602, 604 is shown as defining two spaces for receiving items. In other examples, a single space may be defined, or three or more such spaces may be defined. As with other examples, the bars/pipes shown as forming each holder 602, 604 may have any suitable shape, and may be wrapped or covered with padding material, if desired.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An apparatus for securing a transport item in a transportation space comprising:
a first frame having a first frame top bar, a first frame bottom bar, and at least two first frame vertical bars;
a second frame having a second frame top bar, a second frame bottom bar, and at least two second frame vertical bars; and
at least first and second coupling bars, each coupling bar having a vertical member and first and second horizontal members, the first and second coupling bars each pivotably coupled to each of the first and second frames by each of the first and second horizontal members thereof, thereby defining a first receiving space between the first and second frames for receiving and securing the transport item.

2. The apparatus as in claim 1, further comprising at least a first inner frame coupled to the second frame by at least two linkages.

3. The apparatus as in claim 2, further comprising a third coupling bar and a second inner frame.

4. The apparatus as in claim 2, wherein the linkages are configured to enable the inner frame to move relative to the second frame.

5. The apparatus as in claim 1, wherein the coupling bars are coupled to the first and second frames in a pivoting manner allowing the first receiving space to be minimized or eliminated for a stowed position.

6. The apparatus as in claim 5, wherein the coupling bars are coupled to the first and second frames in a pivoting manner allowing the first receiving space to be maximized for a receiving position in which the transport item can be inserted between the first and second frames.

7. The apparatus as in claim 6, wherein the coupling bars are coupled to the first and second frames in a pivoting manner allowing the first receiving space to be reduced from the receiving position to a storage position for storing a received transport item for transit.

8. The apparatus as in claim 6, wherein the first horizontal members are configured to support an item placed in the first receiving space when in the receiving and stowed positions.

9. The apparatus as in claim 8, further comprising a plurality of rollers on the first horizontal members of the coupling bars.

10. The apparatus as in claim 6, wherein the first and second frames define a top and a bottom and first and second lateral sides such that, when in the receiving position, the transport item may be inserted between either the first lateral sides of the first and second frames, or between the second lateral sides of the first and second frames.

11. The apparatus as in claim 1, wherein the apparatus further defines a second receiving space between the coupling bars and the first frame.

12. The apparatus as in claim 1, wherein at least one of the coupling bars is coupled to at least one of the first and second frames using a knob adapted to be manually actuated to lock and unlock a relative pivot position between the coupling bar and the first and second frames.

13. An apparatus as in claim 1, further comprising at least one caster wheel coupled to the second frame bottom bar.

14. An apparatus as in claim 1, further comprising a plurality of pivoting support bars coupled to at least one of the vertical bars of the first frame, the vertical bars of the second frame, or the vertical members of the coupling bars, wherein the pivoting support bars are configured for a first, stowed position when not in use, and a second, extended position to define an additional horizontal support above the horizontal members of the coupling bar.

15. A system for securing a transport item in a transportation space having a wall, the system comprising:
a first holder having inner, middle and outer vertical bars, a bottom bar, and a top bar, the first holder configured to secure to the wall in a pivoting manner at a first location;
a second holder having inner, middle and outer vertical bars, a bottom bar, and a top bar, the second holder configured to secure to the wall in a pivoting manner at a second location distant from the first location; and
a strap having a first end secured relative to the wall and a second end configured to attach to the top bar of the first holder;
wherein each of the first and second holders define first and second receiving spaces for receiving an item to be transported therein, said first receiving spaces bounded by the respective inner and middle vertical bars and bottom and top bars, and said second receiving spaces bounded by the respective inner and outer vertical bars and bottom and top bars, and the strap is configured to attach to the top bar of the first holder so as to secure an item to be transported in at least one of the first and second receiving spaces.

16. The system of claim 15 wherein the strap is elastic such that, when secured to the top bar with an item stored in at least one of the first and second receiving spaces, the stored item is placed under a compressive force.

17. An apparatus for securing a transport item in a transportation space having a wall, the apparatus comprising:
a first holder having a first holder top bar, a first holder bottom bar, a first holder front bar, and a first holder back bar;
a second holder having a second holder top bar, a second holder front bar, and a second holder bottom bar; and
at least a first holder bracket coupled to the first holder back bar and configured for holding the first holder against the wall; wherein:
the second holder top bar is pivotally coupled to the first holder front bar; and
the second holder bottom bar is pivotally coupled to the first holder front bar.

18. The apparatus of claim 17 further comprising:
a first lock for securing the second holder top bar to the first holder front bar in a desired angle; and
a second lock for securing the first holder in a desired configuration relative to the wall to which the first holder bracket is coupled.

19. The apparatus of claim 17 wherein:
the first holder back bar includes a bottom portion with a base;
the first holder front bar includes a bottom portion with a first wheel; and
the second holder front bar includes a bottom portion with a second wheel.

20. A system for securing a transportation item in a transportation space having a wall with a wall rail thereon, the system comprising first and second apparatuses as in claim 17, provided with the first bracket holders of each of the first and second apparatuses coupled to the wall rail at a desired distance from one another, such that the respective first holders of the first and second apparatuses define a first space bounded by the front, back, top and bottom bars thereof to receive the transportation item.
